(19) United States
(12) Patent Application Publication
(10) Pub. No.: US 2020/0002237 A1
(43) Pub. Date: Jan. 2, 2020

(54) POROUS CERAMIC PARTICLE AND POROUS CERAMIC STRUCTURE

(71) Applicant: NGK INSULATORS, LTD., Nagoya-shi (JP)

(72) Inventors: Akinobu Oribe, Nagoya-shi (JP); Takahiro Tomita, Nagoya-shi (JP)

(73) Assignee: NGK INSULATORS, LTD., Nagoya-shi (JP)

(21) Appl. No.: 16/565,883

(22) Filed: Sep. 10, 2019

Related U.S. Application Data
(63) Continuation of application No. PCT/JP2018/007845, filed on Mar. 1, 2018.

(30) Foreign Application Priority Data
Mar. 29, 2017 (JP) 2017-064525

(51) Int. Cl. C04B 38/00

(52) U.S. Cl. CPC C04B 38/0093; C04B 38/0058; C04B 2235/5445; C04B 2235/5292; C04B 2235/5436; C04B 38/0038

(57) ABSTRACT

A porous ceramic particle (16) has a pair of main surfaces (161, 162) in parallel with each other. An average porosity in a range (633) extending from one main surface (161) toward the other main surface (162) and having a thickness which is one fourth of a particle thickness that is a distance between the main surfaces is higher than that in a range (632) which is positioned in the center between the pair of main surfaces and has a thickness which is half of the particle thickness. The upper main surface (161) is a surface to be placed on an object. By limiting an area having a high porosity to the vicinity of the one main surface (161), it is possible to cause the porous ceramic particle (16) to have low thermal conductivity and low heat capacity and suppress a decrease in the mechanical strength.

The present application is a continuation application of International Application No. PCT/JP2018/007845, filed on Mar. 1, 2018, which claims priority to Japanese Patent Application No. 2017-064525, filed on Mar. 29, 2017. The contents of these applications are incorporated herein by reference in their entirety.

### TECHNICAL FIELD

The present invention relates to a porous ceramic particle and a porous ceramic structure.

### BACKGROUND ART

On an inner wall of a combustion chamber of an engine, conventionally, provided is a thermal insulation film of low thermal conductivity. WO 2015/080065 (Document 1), for example, discloses a thermal insulation film in which porous materials are dispersed as a filler in a matrix. WO 2015/115667 (Document 2) discloses a technique to cover an entire surface of a center portion of a filler with an outer peripheral portion having porosity lower than that of the center portion in order to suppress a decrease in the thermal insulation effect due to infiltration of matrix components into pores of the filler.

WO 2013/125704 (Document 3) discloses a technique to form a thermal insulation layer on an inner wall of a combustion chamber of an engine and form a surface dense layer on a surface of the thermal insulation layer. In the thermal insulation layer, hollow particles or porous particles are dispersed as a filler in a matrix. The thermal insulation layer is formed by applying matrix materials including the filler onto the inner wall of the combustion chamber of the engine, drying, and then performing thermal processing. The surface dense layer is formed by applying materials including ceramics onto the surface of the thermal insulation layer, drying, and then performing thermal processing.

As shown in Documents 1 to 3, in the thermal insulation film in which the filler is dispersed in the matrix, it is not easy to uniformly disperse the filler. As a result, since there are more areas in which only matrices having thermal conductivity higher than that of the filler are gathered in the thermal insulation film, this causes a limitation on an increase in the thermal insulation performance of the thermal insulation film. Further, as shown in Document 3, in the case where the thermal insulation layer and the surface dense layer are formed in this order on the inner wall of the combustion chamber of the engine, the time required to form each layer increases and it is not easy to uniform the thickness of each layer. Furthermore, in Document 2, since the entire surface of the filler is covered with the outer peripheral portion having relatively high thermal conductivity, this causes a limitation on a decrease in the thermal conductivity.

On the other hand, when the porosity of a thermal insulation material is simply made higher in order to reduce the thermal conductivity, the mechanical strength of the thermal insulation material disadvantageously decreases. The above problem is common to materials required to ensure the strength while maintaining the porosity to some degree even in use other than thermal insulation.

### SUMMARY OF INVENTION

The present invention is intended for a porous ceramic particle, and it is an object of the present invention to provide a porous ceramic particle of low thermal conductivity and low heat capacity, in which a decrease in the mechanical strength is suppressed.

The porous ceramic particle according to the present invention has a plate-like shape having a pair of main surfaces in parallel with each other. In the porous ceramic particle, an average porosity in a range of one fourth of a particle thickness which is a distance between the pair of main surfaces, the range of one fourth of a particle thickness existing from one main surface toward the other main surface among the pair of main surfaces, is higher than that in a range of half of the particle thickness which is positioned in the center between the pair of main surfaces.

In one preferred embodiment of the present invention, a plurality of recessed portions each of which is larger than a pore which is open in the one main surface are present in the one main surface. A range in which the plurality of recessed portions are present in a thickness direction is not smaller than 0.5 μm and not larger than one fourth of the particle thickness.

In another preferred embodiment of the present invention, the porous ceramic particle includes a first porous portion including the one main surface, pores being present substantially uniformly in the first porous portion, and a second porous portion being in contact with the first porous portion and including the range which is positioned in the center between the pair of main surfaces and has a thickness which is half of the particle thickness, pores being present substantially uniformly in the second porous portion. The average porosity of the first porous portion is higher than that of the second porous portion.

In still another preferred embodiment of the present invention, the porous ceramic particle includes a first porous portion including the one main surface, pores being present substantially uniformly in the first porous portion, and a second porous portion being in contact with the first porous portion and including the range which is positioned in the center between the pair of main surfaces and has a thickness which is half of the particle thickness, pores being present substantially uniformly in the second porous portion. The average pore diameter of the first porous portion is larger than that of the second porous portion.

Preferably, the thickness of the first porous portion is not smaller than 0.5 μm and not larger than one fourth of the particle thickness. Preferably, the average porosity of the first porous portion is not lower than 30% and not higher than 95%, and the average porosity of the second porous portion is not lower than 30% and lower than the average porosity of the first porous portion. More preferably, not smaller than 50% of the other main surface is a surface of a dense layer.

The present invention is also intended for a porous ceramic structure. The porous ceramic structure according to the present invention includes a supporting member and a porous ceramic aggregate adhered on the supporting member. The porous ceramic aggregate includes a plurality of porous ceramic particles each of which has the same structure as that of the above-described porous ceramic particle. The plurality of porous ceramic particles are arranged, with respective side surfaces thereof opposed to each other, and the other main surfaces of the plurality of porous ceramic particles are adhered on the supporting member.

In one preferred embodiment of the present invention, in the porous ceramic structure, the porous ceramic aggregate is a member to be placed on an object, and a planar shape of the porous ceramic aggregate viewed from an upper surface is the same as that of an area of the object viewed from an upper surface, the porous ceramic aggregate being to be placed on the area.

Preferably, a clearance between adjacent porous ceramic particles in the porous ceramic aggregate is not smaller than 0.1 μm and not larger than 20 μm. Preferably, there are different number densities of porous ceramic particles in the porous ceramic aggregate, and a ratio of a maximum value of the number density to a minimum value thereof is larger than 1.2. Preferably, a material of the supporting member is any one of a resin, cloth, rubber, wood, paper, carbon, a metal, ceramic, and glass or a composite material of two or more materials selected from these materials.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a perspective view showing a porous ceramic structure;

FIG. 2 is a sectional view showing a porous ceramic particle;

FIG. 3 is a sectional view showing an example of a porous portion;

FIG. 4 is a sectional view enlargedly showing a boundary between a green body and a polyester film;

FIG. 5 is a side elevational view showing a manner in which the porous ceramic particles are placed on an object;

FIG. 6 is a side elevational view showing the manner in which the porous ceramic particles are placed on the object;

FIG. 7 is a view showing another example of a porous ceramic particle;

FIG. 8 is a view for explaining a method of manufacturing the porous ceramic particle;

FIG. 9 is a view for explaining the method of manufacturing the porous ceramic particle;

FIG. 10 is a view showing still another example of a porous ceramic particle;

FIG. 11 is a plan view showing a plurality of porous ceramic particles;

FIG. 12 is another plan view showing the plurality of porous ceramic particles;

FIG. 13 is still another plan view showing the plurality of porous ceramic particles; and

FIG. 14 is a longitudinal section showing the porous ceramic structure.

### DESCRIPTION OF EMBODIMENTS

FIG. 1 is a perspective view showing a porous ceramic structure 10 in accordance with one preferred embodiment of the present invention. The porous ceramic structure 10 includes a sheet 12 and a porous ceramic aggregate 14. The porous ceramic aggregate 14 is adhered on the sheet 12. In other words, the porous ceramic aggregate 14 is fixed removably on the sheet 12. The sheet 12 is one form of a supporting member which supports the porous ceramic aggregate 14.

The porous ceramic aggregate 14 is fixed on the sheet 12 by, for example, an adhesive force of the sheet 12. The sheet 12 is, for example, a resin sheet or a resin film having an adhesive force. The adhesive force (JIS Z0237) of the sheet 12 is preferably 1.0 N/10 mm or higher. The porous ceramic aggregate 14 can be thereby firmly fixed. The porous ceramic aggregate 14 may be temporarily firmly fixed on the sheet 12 with an adhesion interface. The porous ceramic aggregate 14 may be fixed on the sheet 12 through an adhesive agent or the like.

The adhesive force of the sheet 12 is reduced by applying heat, water, a solvent, electricity, light (including ultraviolet light), microwaves, an external force or the like to the sheet 12, or the adhesive force is reduced by change over time, or the like. It is thereby possible to easily release the fixed state of the porous ceramic aggregate 14 on the sheet 12 and remove the porous ceramic aggregate 14 from the sheet 12. The adhesive force of the sheet 12 at the time when the porous ceramic aggregate 14 is removed is preferably 0.1 N/10 mm or lower. It is thereby possible to easily remove the porous ceramic aggregate 14 from the sheet 12.

The porous ceramic aggregate 14 includes a plurality of porous ceramic particles 16. Actually, the number of porous ceramic particles 16 included in the porous ceramic aggregate 14 is more than the number shown in FIG. 1. The number of porous ceramic particles 16 included in the porous ceramic aggregate 14 may be less than the number shown in FIG. 1. In the exemplary case shown in FIG. 1, respective shapes of the plurality of porous ceramic particles 16 in a plan view (i.e., planar shapes) are different from one another. The porous ceramic aggregate 14 may include two or more porous ceramic particles 16 having substantially the same planar shape.

The above-described word “porous” refers to a state which is not dense nor hollow. A porous structure is formed of, for example, a plurality of pores and a plurality of fine particles. The dense structure is a state in which a plurality of fine particles exist closer to one another than in the porous structure. The porosity in the dense structure is lower than that in the porous structure. In the dense structure, the plurality of fine particles may be combined with almost no clearance. In other words, the dense structure may have almost no pore inside. A hollow structure is a state in which an outer shell portion has the dense structure and the inside of the outer shell portion is hollow.

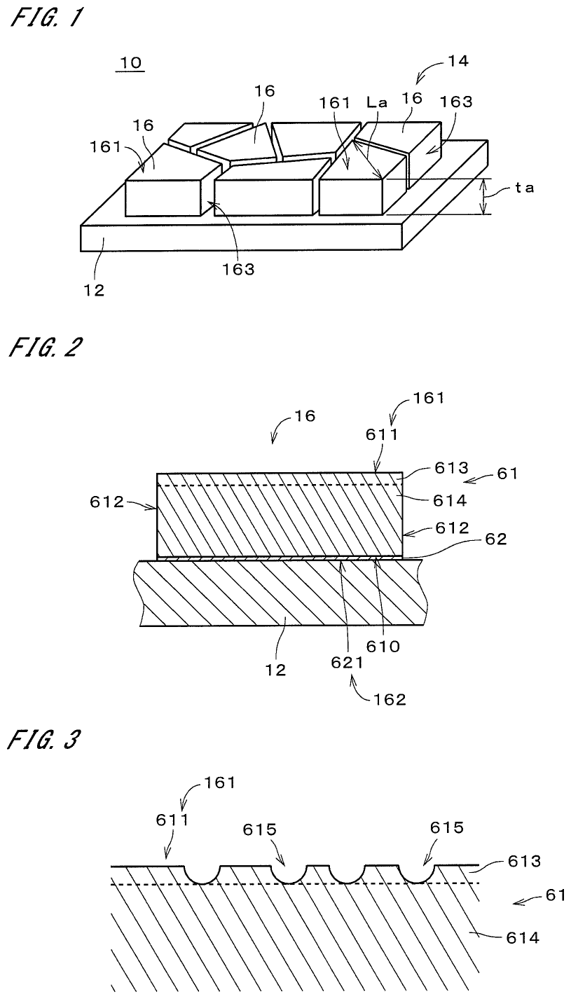

FIG. 2 is a longitudinal section showing one porous ceramic particle 16. FIG. 2 also shows part of the sheet 12. Each of the plurality of porous ceramic particles 16 (see FIG. 1) included in the porous ceramic aggregate 14 has substantially the same structure as that shown in FIG. 2.

The porous ceramic particle 16 has a plate-like shape having a pair of main surfaces 161 and 162 in parallel with each other. The porous ceramic particle 16 includes a porous portion 61 and a dense layer 62. The porous portion 61 is a plate-like portion having a pair of main surfaces 611 and 610 substantially in parallel with each other. The dense layer 62 substantially entirely covers one main surface 610 of the porous portion 61.

The upper main surface 161 of the porous ceramic particle 16 is the upper main surface 611 of the porous portion 61. The lower main surface 162 of the porous ceramic particle 16 is a surface 621 of the dense layer 62. The dense layer 62 does not need to entirely cover the main surface 611 of the porous portion 61, but preferably covers not less than 50% thereof. Specifically, it is preferable that not less than 50% of the lower main surface of the porous ceramic particle 16 should be the surface of the dense layer 62. In the exemplary case shown in FIG. 2, the dense layer 62 substantially entirely covers the lower main surface 610 of the porous portion 61. The dense layer 62 covers only the lower main surface 610 of the porous portion 61.

Further, the dense layer may be omitted in the porous ceramic particle 16. In this case, the upper main surface 161 of the porous ceramic particle 16 is the upper main surface 611 of the porous portion 61 and the lower main surface 162 thereof is the lower main surface 610 of the porous portion 61.

A portion of a surface of the porous portion 61 except the main surface 610 is exposed from the dense layer 62. Specifically, as shown in FIG. 2, a substantially entire side surface 612 of the porous portion 61 is not covered with the dense layer 62 but is exposed from the dense layer 62. The upper main surface 611 of the porous portion 61 is also exposed from the dense layer 62.

The thickness in a thickness direction of the porous portion 61 (hereinafter, referred to as a “porous thickness”) is preferably not smaller than 50 μm and not larger than 500 μm, and further preferably not smaller than 55 μm and not larger than 400 μm. The porous thickness is more preferably not smaller than 60 μm and not larger than 300 μm, and especially preferably not smaller than 70 μm and not larger than 200 μm. The above-described thickness direction is a direction perpendicular to the main surface 611 of the porous portion 61.

The porous portion 61 includes a first porous portion 613 and a second porous portion 614. The average porosity of the first porous portion 613 is higher than that of the second porous portion 614. As described later, there are some forms in which a boundary between the first porous portion 613 and the second porous portion 614 cannot be determined. The “porosity” refers to a ratio of an area in which there is no skeleton particle in a cross sectional image acquired by an electron microscope. It may be determined that the porosity refers to a ratio of a range in which there is no skeleton particle on a straight line drawn in the cross sectional image.

FIG. 3 is a sectional view showing an example of the porous portion 61. In the exemplary case shown in FIG. 3, in the upper main surface 611 of the porous portion 61, there are a plurality of recessed portions 615 each of which is larger than a pore which is open in the main surface 611. The phrase “larger than a pore which is open” means that a sphere having a diameter equal to the average pore diameter can be easily accommodated therein. In the present specification, the “average pore diameter” is a value obtained by measurement using a mercury porosimeter (mercury press-in method). When the average pore diameter is not larger than 10 nm, the measurement is performed by the gas adsorption method.

In the exemplary case shown in FIG. 3, in the thickness direction, i.e., a direction perpendicular to the main surface 611, a range in which the plurality of recessed portions 615 are present is determined as the first porous portion 613. A portion of the porous portion 61, which is other than the first porous portion 613, is determined as the second porous portion 614. When the presence of the recessed portions 615 is not taken into consideration, the porous portion 61 has almost uniform porosity. In other words, in an area of the porous portion 61 except the recessed portions 615, the pores are present almost uniformly. The phrase “the pores are present uniformly” means that in any area sufficiently larger than the size of the pore, the distribution of the pore diameters is uniform. With the presence of the recessed portions 615, the average porosity of the first porous portion 613 is higher than that of the second porous portion 614.

It is preferable that the thickness of the first porous portion 613, i.e., the depth of the recessed portion 615 should be not smaller than 0.5 μm. It thereby becomes possible to make the recessed portion 615 clearly larger than an opening of a micropore and produce an effect of increasing thermal insulation performance. More preferably, the depth of the recessed portion 615 is not smaller than 1 μm. In order to ensure the strength of the porous ceramic particle 16, it is preferable that the thickness of the first porous portion 613 should be not larger than one fourth of the thickness of the porous ceramic particle 16 (hereinafter, referred to as a “particle thickness”). The particle thickness is a distance between both the main surfaces 161 and 162 of the porous ceramic particle 16. Further preferably, the thickness of the first porous portion 613 is not larger than 15 μm.

Respective positions of the main surfaces 161 and 162 in the thickness direction of the porous ceramic particle 16 are determined, for example, as positions at which a ratio of a range in which the skeleton particle is present on a straight line which is so drawn in the cross sectional image as to be tangent to the main surfaces 161 and 162 and have a predetermined length becomes not less than a predetermined value while the straight line is being gradually moved toward the inside of the porous ceramic particle 16. The predetermined value is, for example, 5%. If approximate positions of the main surfaces 161 and 162 can be specified, any other method may be adopted. Respective positions of the main surfaces 611 and 610 in the thickness direction of the porous portion 61 can be determined in the same manner.

It is preferable that a ratio of the area of the recessed portion 615 to that of the main surface 161 in a plan view should be not less than 10% and not more than 50%. More preferably, the ratio is not less than 20% and not more than 50%. The shape of the recessed portion 615 in a plan view is not limited to circle or ellipse but may be polygonal or linear. The width of the recessed portion 615 is preferably not smaller than 0.1 μm and not larger than 30 μm, and further preferably not smaller than 0.5 μm and not larger than 30 μm. The width of the recessed portion 615 is determined, for example, as a diameter of the maximum inscribed circle.

The average porosity of the first porous portion 613 is preferably not lower than 30% and not higher than 95%, more preferably not lower than 40% and not higher than 95%, and especially preferably not lower than 50% and not higher than 95%. The average porosity of the second porous portion 614 is lower than that of the first porous portion 613 and not higher than 75%, more preferably not higher than 70%, and especially preferably not higher than 65%. The average porosity of the second porous portion 614 is preferably not lower than 30%.

The pores in the porous portion 61 include an open pore which is open in the surface of the porous portion 61. The pores in the porous portion 61 may include a closed pore. The shape of the pore in the porous portion 61 is not particularly limited but may be any one of various shapes.

The average pore diameter of a portion of the porous portion 61 except the recessed portions 615 is preferably not larger than 500 nm, and further preferably not smaller than 10 nm and not larger than 500 nm. It is thereby possible to suitably inhibit occurrence of lattice vibration (phonon) which is a main cause of thermal conduction in the porous portion 61.

The portion of the porous portion 61 except the recessed portions 615 has a structure in which fine particles are three-dimensionally connected. The fine particles are particles forming a skeleton of the porous portion 61, and hereinafter are also referred to as “skeleton particles”. The particle diameter of the skeleton particle of the porous portion 61 is preferably not smaller than 1 nm and not larger than 5 μm, and further preferably not smaller than 50 nm and not larger than 1 μm. It is thereby possible to suitably inhibit occurrence of lattice vibration (phonon) which is a main cause of thermal conduction in the porous portion 61 and to reduce the thermal conductivity of the porous ceramic particle 16. The skeleton particle of the porous portion 61 may be a particle formed of one crystal grain (i.e., monocrystalline particle) or may be a particle formed of a multitude of crystal grains (i.e., polycrystalline particle). The particle diameter of the skeleton particle is obtained by, for example, measuring the size of one fine particle included in a group of particles forming the skeleton of the porous portion 61 (for example, the diameter when the fine particle is spherical, or the maximum diameter when not spherical) from an image or the like obtained by observation using the electron microscope.

The thermal conductivity of the second porous portion 614 is preferably lower than 1.5 W/mK, and further preferably not higher than 0.7 W/mK. The thermal conductivity of the second porous portion 614 is more preferably not higher than 0.5 W/mK, and especially preferably not higher than 0.3 W/mK.

The thermal conductivity of the first porous portion 613 is preferably lower than 1.3 W/mK, and further preferably not higher than 0.5 W/mK. The thermal conductivity of the first porous portion 613 is more preferably not higher than 0.3 W/mK, and especially preferably not higher than 0.1 W/mK.

The heat capacity of the second porous portion 614 is preferably not higher than 1200 kJ/m³K, and further preferably not higher than 1000 kJ/m³K. The heat capacity of the second porous portion 614 is more preferably not higher than 800 kJ/m³K, and especially preferably not higher than 500 kJ/m³K.

The heat capacity of the first porous portion 613 is preferably not higher than 1000 kJ/m³K, and further preferably not higher than 800 kJ/m³K. The heat capacity of the porous portion 61 is more preferably not higher than 600 kJ/m³K, and especially preferably not higher than 400 kJ/m³K.

It is preferable that the porous portion 61 should include a metal oxide as a constituent material, and further preferable that the porous portion 61 should be formed only of the metal oxide. The metal oxide has ion binding properties between the metal and oxygen which are stronger than those of a nonoxide of metal (for example, a carbide or a nitride). For this reason, since the porous portion 61 includes a metal oxide, the thermal conductivity of the porous portion 61 becomes lower.

The oxide included in the porous portion 61 is preferably an oxide of one element or a composite oxide of two or more elements, which are selected out of a group consisting of Zr, Y, Al, Si, Ti, Nb, Sr, La, Hf, Ce, Gd, Sm, Mn, Yb, Er, and Ta. This makes it hard to cause thermal conduction due to the lattice vibration (phonon) in the porous portion 61.

As the specific material of the porous portion 61, used is a material obtained by adding SiO₂, TiO₂, La₂O₃, Gd₂O₃, Yb₂O₃, Er₂O₃, or the like to ZrO₂—Y₂O₃. More specifically, ZrO₂—HfO₂—Y₂O₃, ZrO₂—Y₂O₃—La₂O₃, ZrO₂—HfO₂—Y₂O₃—La₂O₃, HfO₂—Y₂O₃, CeO₂—Y₂O₃, Gd₂Zr₂O₇, Sm₂Zr₂O₇, LaMnAl₁₁O₁₉, YTa₃O₉, Y_{0.7}La_{0.3}Ta₃O₉, Y_{1.08}Ta_{2.76}Zr_{0.24}O₉, Y₂Ti₂O₇, LaTa₃O₉, Yb₂Si₂O₇, Y₂Si₂O₇, Ti₃O₅, or the like is used as the material of the porous portion 61.

The dense layer 62 has porosity lower than that of the second porous portion 614. The dense layer 62 includes, for example, almost no pore. The surface 621 of the dense layer 62 (in other words, a main surface on the opposite side of the porous portion 61) is a smooth surface. The arithmetic average roughness (Ra) of the surface 621 of the dense layer 62 is preferably not smaller than 50 nm and not larger than 800 nm.

The dense layer 62 preferably includes Si as the constituent material, and further preferably includes an oxide of Si as a main component. It is thereby possible to easily smooth the surface 621 of the dense layer 62. Further, a dense layer material which is the constituent material of the dense layer 62 may have the same composition as that of the porous portion 61.

The thickness of the dense layer 62 is preferably not smaller than 10 nm and not larger than 1000 nm. The thickness of the dense layer 62 is preferably larger than 0% of the thickness of the porous portion 61 and not larger than 1% thereof In FIG. 2, the thickness of the dense layer 62 is shown larger than actual one. The thickness of the dense layer 62 is preferably not smaller than 0.1 times the average particle diameter of the skeleton particle of the porous portion 61 and not larger than ten times thereof The thickness of the dense layer 62 is preferably not smaller than 0.05 times an average pore diameter of the porous portion 61 and not larger than five times thereof.

The thickness of the dense layer 62 is a distance between the surface 621 of the dense layer 62 and the main surface 610 of the porous portion 61 in the thickness direction. The main surface 610 of the porous portion 61 is also an interface between the dense layer 62 and the porous portion 61. The method of determining the interface between the dense layer 62 and the porous portion 61 is as follows.

First, an image of longitudinal section of the porous ceramic particle 16 is acquired by using the electron microscope or the like. Subsequently, in the image of longitudinal section, a plurality of straight lines (hereinafter, referred to as “interface candidate lines”) in parallel with the surface 621 of the dense layer 62 are set on the porous ceramic particle 16 at an interval of 10 nm. Next, the interface candidate line closest to the surface 621 of the dense layer 62 is specified, and on the specified interface candidate line, a total length L_{dense} of a line segment overlapping the dense layer 62, a total length L_{grain} of a line segment overlapping the skeleton particle of the porous portion 61, and a total length Lₚₒᵣₑ of a line segment overlapping the pore are obtained. Then, obtained is a ratio of Lₚₒᵣₑ to the total of L_{dense}, L_{grain}, and Lₚₒᵣₑ (in other words, Lₚₒᵣₑ/(L_{dense}+L_{grain}+Lₚₒᵣₑ), and hereinafter, referred to as a “pore length ratio”).

When the pore length ratio is smaller than a predetermined threshold value, the pore length ratio is obtained with the interface candidate line which is second closest to the surface 621 of the dense layer 62, next to the current specified interface candidate line, (i.e., the interface candidate line adjacent to the specified interface candidate line on the opposite side of the surface 621) as a new specified interface candidate line. Then, until the pore length ratio of the specified interface candidate line becomes not smaller than the above-described threshold value, the pore length ratio is obtained while the specified interface candidate line is sequentially changed. In this determination method, the position of the interface candidate line at which the pore length ratio first becomes the above-described threshold value or more is determined as a position of the interface between the dense layer 62 and the porous portion 61. In other words, among the interface candidate lines on which the pore length ratio is not smaller than the above-described threshold value, the position of the interface candidate line closest to the surface 621 of the dense layer 62 is determined as the position of the interface between the dense layer 62 and the porous portion 61. The threshold value is, for example, 0.3.

In the above-described method of determining the interface, when the pore length ratio of the interface candidate line closest to the surface 621 of the dense layer 62, among the interface candidate lines on which the pore length ratio is not smaller than the threshold value, is larger than the threshold value, between the interface candidate line and an interface candidate line adjacent to the interface candidate line on the side of the surface 621, a position at which the pore length ratio is equal to the threshold value may be obtained by interpolation and determined as a position of the interface between the dense layer 62 and the porous portion 61.

When the dense layer material which is a material forming the dense layer 62 extends into the inside of the porous portion 61 (i.e., inside the pore of the porous portion 61) from the dense layer 62 beyond the above-described interface, the thickness of the dense layer material existing on the side of the porous portion 61 from the interface between the dense layer 62 and the porous portion 61 is preferably larger than 0% of the thickness of the dense layer 62 and not larger than 10% thereof. Further, the thickness of the dense layer material existing on the side of the porous portion 61 from the interface between the dense layer 62 and the porous portion 61 is sometimes larger than 10% of the thickness of the dense layer 62, and in this case, the thickness of the dense layer material is, for example, several μm.

The aspect ratio of the porous ceramic particle 16 shown in FIG. 1 is preferably not less than 3, further preferably not less than 5, and more preferably not less than 7. The aspect ratio of the porous ceramic particle 16 is a ratio (i.e., La/ta) of the maximum length La of the main surface 161 (or the main surface 162 in FIG. 2, and hereinafter, the same applies to the description of the aspect) of the porous ceramic particle 16 to the particle thickness ta of the porous ceramic particle 16. The main surface 161 is the widest plane among a plurality of planes forming the porous ceramic particle 16, and in the exemplary case shown in FIG. 2, the main surface 161 is the upper main surface 611 of the porous portion 61 or the surface 621 of the dense layer 62.

When the shape of the main surface 161 is square, rectangle, trapezoid, parallelogram, or polygon (for example, pentagon or hexagon), the maximum length La is the length of the longest diagonal line of the main surface 161. When the shape of the main surface 161 is circle, the maximum length La is the diameter of the main surface 161. When the shape of the main surface 161 is ellipse, the maximum length La is the longer diameter of the main surface 161.

The particle thickness ta is preferably not smaller than 50 μm and not larger than 500 μm, and further preferably not smaller than 55 μm and not larger than 300 μm. The variation in the particle thickness ta in the porous ceramic aggregate 14 is preferably not higher than 10%. In other words, the difference between the maximum value and the minimum value of the particle thickness ta is not higher than 10% of the average value of the maximum value and the minimum value of the particle thickness ta. As described later, when a plurality of porous ceramic particles 16 are set on an object to form a thermal insulation film, it is thereby possible to increase uniformity of the thickness of the thermal insulation film. As a result, it is possible to increase thermal insulation performance of the thermal insulation film.

The thermal conductivity of the porous ceramic particle 16 is preferably lower than 1.5 W/mK, and further preferably not higher than 0.7 W/mK. The thermal conductivity of the porous ceramic particle 16 is more preferably not higher than 0.5 W/mK, and especially preferably not higher than 0.3 W/mK.

The heat capacity of the porous ceramic particle 16 is preferably not higher than 1200 kJ/m³K, and further preferably not higher than 1000 kJ/m³K. The heat capacity of the porous ceramic particle 16 is more preferably not higher than 800 kJ/m³K, and especially preferably not higher than 500 kJ/m³K.

Next, an exemplary method of manufacturing the porous ceramic particle 16 will be described. First, by adding and mixing a pore-forming material, a binder, a plasticizer, a solvent, or the like to powder of the constituent material of the porous portion 61, a casting slurry is prepared. Subsequently, by performing a vacuum degassing process on the casting slurry, viscosity adjustment is performed, and then a green body (green sheet) is prepared by tape casting. For example, the casting slurry is placed on a polyester film, and the green body is prepared by using a doctor blade and the like so that the thickness after sintering may become a desired one.

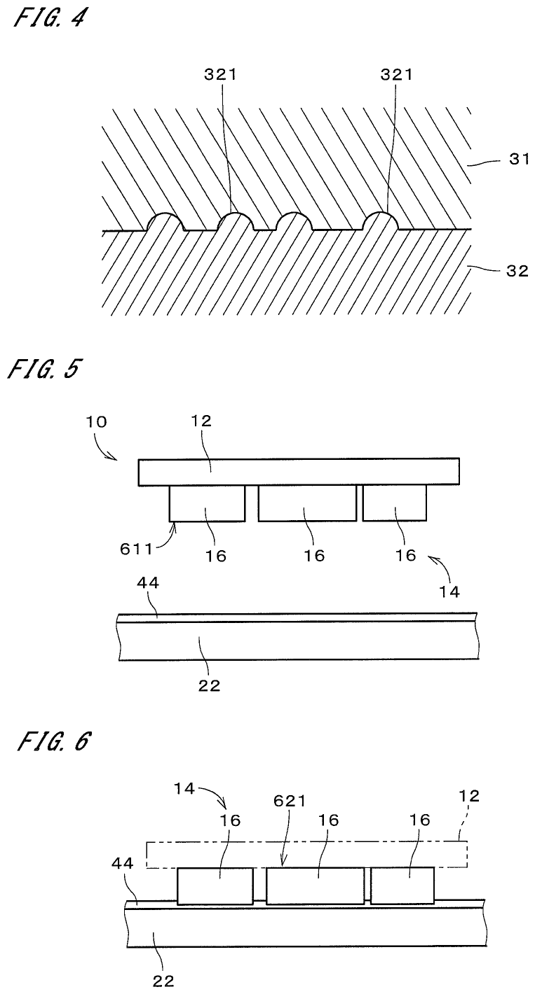

FIG. 4 is a sectional view enlargedly showing a boundary between a green body 31 and a polyester film 32. On the film 32, a large number of very small projected portions 321 are formed. For this reason, in the lower surface of the green body 31, very small recessed portions are formed, being engaged with the projected portions 321. The projected portion may be punctate or linear.

Next, the green body 31 is removed from the polyester film 32 and collected. By sintering the collected green body 31, a plate-like sintered body is formed. A large number of very small recessed portions existing in a removal surface of the green body 31 become the recessed portions 615 shown in FIG. 3 by sintering.

After the above-described sintered body is formed, a raw material liquid containing the constituent material of the dense layer 62 is applied onto one main surface of the sintered body. Application of the raw material liquid to the sintered body is performed by, for example, dipping, spray coating, spin coating, or roll coating. Subsequently, by performing mild sintering and the like, crosslinking, sintering, polymerization, and the like of the constituent material of the dense layer 62 proceed, to thereby form an original member in which a surface layer having a dense structure is provided on the main surface of the sintered body. The surface layer is a portion to become the dense layer 62. Further, the original member is a member to become the plurality of porous ceramic particles 16. The surface layer which corresponds to the dense layer 62 may be formed by any other method.

In formation of the original member, before the raw material liquid is applied to the sintered body, a liquid which promotes the crosslinking and the like of the raw material liquid may be applied on the main surface of the sintered body. It is thereby possible to prevent or suppress intrusion of the raw material liquid to the inside of the sintered body. When the raw material liquid contains a ceramic precursor (alkoxide, polysilazane, or the like of a metal such as Si, Al, or the like), for example, an additive (water or the like) which promotes conversion into ceramic is applied onto the main surface of the sintered body before the application of the raw material liquid.

Next, the original member is adhered onto the sheet 12 with the surface layer opposed to the surface of the sheet 12. The surface layer having the dense structure is firmly adhered onto the sheet 12. After that, by dividing the original member on the sheet 12, formed is the porous ceramic structure 10 in which the plurality of porous ceramic particles 16 (i.e., the porous ceramic aggregate 14) are adhered on the sheet 12. As described above, since the original member is firmly adhered on the sheet 12, it is possible to prevent or suppress removal of the porous ceramic particles 16 from the sheet 12 when the original member is divided. Division of the original member may be performed by any one of various methods. By cutting (or cracking) the original member with an edge tool being pressed thereagainst, for example, the plurality of porous ceramic particles 16 may be formed. Alternatively, by cutting the original member with a laser or the like, the plurality of porous ceramic particles 16 may be formed.

In the above-described case, though the surface layer which is to become the dense layer 62 is formed after the sintered body which is to become the porous portion 61 is formed, the sintered body and the surface layer may be formed substantially at the same time. For example, by sintering after applying the raw material liquid onto the green body which is to become the sintered body, the original member may be formed. In this case, in the porous ceramic particle 16, it is possible to prevent (or suppress) intrusion of the dense layer material which is the constituent material of the dense layer 62 to the inside of the porous portion 61.

In the porous ceramic structure 10, as shown in FIG. 1, each of the plurality of porous ceramic particles 16 is arranged adjacent to one of the other porous ceramic particles 16 while respective side surfaces 163 are opposed to each other. In other words, each porous ceramic particle 16 is arranged adjacent to one of the other porous ceramic particles 16 while respective side surfaces 612 of the porous portion 61 (see FIG. 2) exposed from the dense layer 62 (see FIG. 2) are opposed to each other. The surface 621 of the dense layer 62 (see FIG. 2) which is one main surface 162 of each porous ceramic particle 16 is adhered on the sheet 12.

Next, a method of setting the plurality of porous ceramic particles 16 on the object by using the porous ceramic structure 10 will be described. The object is, for example, an inner wall of a combustion chamber of an engine. As shown in FIG. 5, first, an adhesive agent 44 is applied onto an object 22. Subsequently, the porous ceramic structure 10 is placed on the object 22 with the plurality of porous ceramic particles 16 of the porous ceramic aggregate 14 opposed to the adhesive agent 44. The main surface 611 of the porous portion 61 shown in FIG. 2 is thereby fixed on the object 22 with the adhesive agent 44. Then, as shown in FIG. 6, the sheet 12 is peeled off and removed from the plurality of porous ceramic particles 16, and the porous ceramic aggregate 14 is thereby placed (in other words, transferred) on the object 22, to form a thermal insulation film on the object 22. The peel-off of the sheet 12 is performed, for example, after the sheet 12 is heated. In the state shown in FIG. 6, the upper surface of the porous ceramic particle 16 is the surface 621 of the dense layer 62.

Thus, by using the porous ceramic structure 10, it is possible to more easily place the plurality of porous ceramic particles 16 on the object 22 as compared with the case of individually placing the porous ceramic particles 16 on the object 22 one by one. Further, it is possible to easily control a clearance among the plurality of porous ceramic particles 16 (i.e., an interval between adjacent porous ceramic particles 16) with high accuracy. On the object 22, the porous ceramic aggregate 14 may be entirely covered with a resin material such as the adhesive agent or the like.

As described above, the porous ceramic particle 16 includes the porous portion 61 and the dense layer 62. The porous portion 61 has a plate-like shape having a pair of main surfaces 611 and 610 in parallel with each other. The porous portion 61 has the first porous portion 613 and the second porous portion 614, and the average porosity of the first porous portion 613 is higher than that of the second porous portion 614. The dense layer 62 has porosity lower than that of the second porous portion 614 and covers the main surface 610 of the second porous portion 614 on the opposite side of the first porous portion 613.

In order to increase the thermal insulation property, if the number of open pores is increased in a portion which can become a surface in use, there is a possibility of deteriorating the thermal insulation property due to intrusion of extraneous matters into the pores. Further, if the number of pores or voids is increased in the entire porous portion, there are some cases where the strength decreases and the durability becomes insufficient under actual use conditions.

In the porous ceramic particle 16, by increasing the number of open pores in the main surface 611 of the first porous portion 613 which is to be a back-side surface, not a front-side surface, in use or enlarging the open pore, the intrusion of extraneous matters into the open pores can be suppressed. Further, though the average porosity of the first porous portion 613 is high, since most of the porous portion 61 is the second porous portion 614, a decrease in the strength of the porous ceramic particle 16 can be suppressed. Furthermore, the strength of the front-side surface of the porous ceramic particle 16 is maintained. On the other hand, with the presence of the first porous portion 613, it is possible to reduce the thermal conductivity and the heat capacity as compared with the case where the porous portion 61 is formed only of the second porous portion 614. As a result, it is possible to provide the porous ceramic particle of low thermal conductivity and low heat capacity, in which a decrease in the mechanical strength is suppressed.

When the green body is formed, by providing projected portions on the sheet, the recessed portions 615 can be easily provided in the porous portion 61. Further, the recessed portion 615 is not limited to a smooth recessed portion but may be such a recessed portion as to sharply cut into. The recessed portions 615 may be formed in the porous portion 61 by roughening or damaging the surface of the sheet to form projected and recessed portions and transferring the projected and recessed portions onto the green body. The recessed portions may be formed on the green body by pressing the green body against a member having projected portions or projected and recessed portions. Punctate or linear recessed portions may be formed by emitting a laser beam to the green body. Further, the recessed portions may be formed on the porous portion 61 by pressing the sintered body against the member having projected portions or projected and recessed portions after sintering, without providing any projected portion on the sheet. Punctate or linear recessed portions may be formed by emitting a laser beam to the sintered body.

Further, since there is no dense layer 62 on the side surface 612 of the porous portion 61, it is possible to prevent heat transfer in the thickness direction through the dense layer 62. As a result, it is possible to increase the thermal insulation performance of the porous ceramic particle 16.

With the dense layer 62, it is possible to prevent or suppress intrusion of extraneous matters to the inside of the porous portion 61 from the main surface 610 of the porous portion 61 on the opposite side of the object 22. As a result, it is possible to prevent or further suppress reduction in the thermal insulation performance of the porous ceramic particle 16 due to the intrusion of extraneous matters.

In the porous ceramic particle 16, the thickness of the dense layer 62 is not more than 1% of the thickness of the porous portion 61. It is thereby possible to reduce the volume fraction of the dense layer 62 to the whole porous ceramic particle 16 and to suppress an increase in the thermal conductivity and the heat capacity due to the dense layer 62.

The thickness of the dense layer 62 is not larger than 1000 nm. It is thereby possible to reduce the volume fraction of the dense layer 62 to the whole porous ceramic particle 16 and to suppress an increase in the thermal conductivity and the heat capacity due to the dense layer 62. Further, the thickness of the dense layer 62 is not smaller than 10 nm. It is thereby possible to facilitate formation of the dense layer 62.

As described above, the thickness of the dense layer 62 is not larger than ten times the average particle diameter of the skeleton particle of the porous portion 61. It is thereby possible to reduce the volume fraction of the dense layer 62 to the whole porous ceramic particle 16 and to suppress an increase in the thermal conductivity and the heat capacity due to the dense layer 62. Further, the thickness of the dense layer 62 is not smaller than 0.1 times the average particle diameter of the skeleton particle of the porous portion 61. It is thereby possible to facilitate formation of the dense layer 62.

The thickness of the dense layer 62 is not larger than five times the average pore diameter of the porous portion 61. It is thereby possible to reduce the volume fraction of the dense layer 62 to the whole porous ceramic particle 16 and to suppress an increase in the thermal conductivity and the heat capacity due to the dense layer 62. Further, the thickness of the dense layer 62 is not smaller than 0.05 times the average pore diameter of the porous portion 61. It is thereby possible to facilitate formation of the dense layer 62.

When the dense layer material which is a material forming the dense layer 62 extends into the inside of the porous portion 61 from the dense layer 62, the thickness of the dense layer material existing on the side of the porous portion 61 from the interface between the dense layer 62 and the porous portion 61 is not larger than 10% of the thickness of the dense layer 62. Thus, by suppressing intrusion of the dense layer material to the inside of the porous portion 61, it is possible to prevent or suppress reduction in the thermal insulation performance of the porous ceramic particle 16.

The arithmetic average roughness of the surface 621 of the dense layer 62 is not larger than 800 nm. Thus, by increasing the smoothness of the surface 621 of the dense layer 62, it is possible to reduce the contact area between the dense layer 62 and high-temperature gas therearound. As a result, it is possible to suppress heat transfer from the high-temperature gas to the dense layer 62. Further, the arithmetic average roughness of the surface 621 of the dense layer 62 is not smaller than 50 nm. It is thereby possible to facilitate formation of the dense layer 62.

In the porous ceramic structure 10, the planar shape of the porous ceramic aggregate 14 viewed from an upper surface (i.e., the surface on the opposite side of the sheet 12) is preferably the same as that of an area of the above-described object 22 where the porous ceramic aggregate 14 is to be placed, when the area is viewed from an upper surface (i.e., a surface on which the porous ceramic aggregate 14 is to be placed). It is thereby possible to transfer the plurality of porous ceramic particles 16 onto the object 22 having any one of various shapes while preventing or suppressing a loss of material (a loss of the porous ceramic particles 16).

Further, the above-described planar shape of the porous ceramic aggregate 14 has only to be substantially the same as the above-described planar shape of the area (hereinafter, referred to as an “aggregate placement area”) of the object 22 where the porous ceramic aggregate 14 is to be placed. Specifically, the planar shape of the porous ceramic aggregate 14 may be exactly the same as the planar shape of the aggregate placement area or may have similarity relation with the planar shape of the aggregate placement area. For example, the planar shape of the porous ceramic aggregate 14 may be similar to that of the aggregate placement area, being enlarged or reduced within a range not smaller than 1.1 times and not larger than 2.0 times.

As to the above description on the porous ceramic particle 16 and the porous ceramic aggregate 14, the same applies to other examples of the porous ceramic particle 16 described below, as long as no inconsistency is caused.

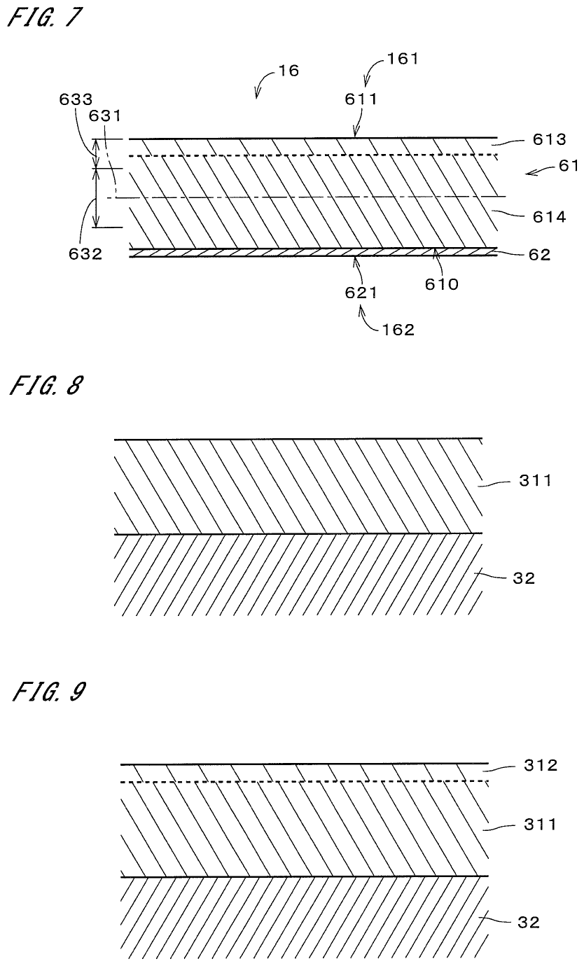

Next, with reference to FIG. 7, two other examples of the porous ceramic particle 16 will be described. In these examples, the recessed portions 615 shown in FIG. 3 are not provided, and the porous portion 61 has a two-layer structure. In one preferred example of the porous ceramic particle 16 (hereinafter, referred to as a “first two-layer example”), the pores are present substantially uniformly in the first porous portion 613. The pores are present substantially uniformly also in the second porous portion 614. The first porous portion 613 includes one main surface 611 of the porous ceramic particle 16. The second porous portion 614 is provided below the first porous portion 613, i.e., on the opposite side of the main surface 611, being in contact with the first porous portion 613. The average porosity of the first porous portion 613 is higher than that of the second porous portion 614.

Preferably, the average pore diameter of the first porous portion 613 is almost equal to that of the second porous portion 614. The average pore diameter in the first porous portion 613 and the second porous portion 614 is not smaller than 0.01 gm and not larger than 2 μm, and preferably not smaller than 0.1 μm and not larger than 2 μm.

A range 632 which is positioned in the center between both the main surfaces 161 and 162 of the porous ceramic particle 16, i.e., in the center between the main surface 611 and the surface 621 of the dense layer 62 and has a thickness which is half of the particle thickness is included in the second porous portion 614. In other words, assuming a virtual plane 631 positioned in the center between both the main surfaces 611 and 621, the second porous portion 614 is present on both sides of the plane 631, extending over a range having a thickness which is one fourth of the particle thickness. As already described, the dense layer 62 may be omitted in the porous ceramic particle 16, and in this case, the lower main surface 610 of the porous portion 61 corresponds to the main surface 162 in the above description.

With the presence of the first porous portion 613, the average porosity of a range 633 extending from the main surface 161 toward the main surface 162 and having a thickness which is one fourth of the particle thickness is higher than that of the range 632 which is positioned in the center between the pair of main surfaces 161 and 162 and has a thickness which is half of the particle thickness.

Also in another preferred example of the porous ceramic particle 16 (hereinafter, referred to as a “second two-layer example”), the pores are present substantially uniformly in the first porous portion 613, and the pores are present substantially uniformly in the second porous portion 614 shown in FIG. 7. The first porous portion 613 includes one main surface 161 of the porous ceramic particle 16. The second porous portion 614 is provided below the first porous portion 613, being in contact with the first porous portion 613. The average porosity of the first porous portion 613 is higher than that of the second porous portion 614.

Herein, the average pore diameter of the first porous portion 613 is larger than that of the second porous portion 614. In other words, since the average pore diameter is larger, the average porosity of the first porous portion 613 is higher than that of the second porous portion 614. The range 632 which is positioned in the center between both the main surfaces 161 and 162 of the porous ceramic particle 16 and has a thickness which is half of the particle thickness is included in the second porous portion 614. The average pore diameter of the first porous portion 613 is not smaller than 0.05 μm and not larger than 20 μm, and preferably not smaller than 0.1 μm and not larger than 20 μm. The average pore diameter of the second porous portion 614 is not smaller than 0.03 μm and not larger than 2 μm, and preferably not smaller than 0.05 μm and not larger than 2 μm.

With the presence of the first porous portion 613, the average porosity of the range 633 extending from the main surface 161 toward the main surface 162 and having a thickness which is one fourth of the particle thickness is higher than that of the range 632 which is positioned in the center between the pair of main surfaces 161 and 162 and has a thickness which is half of the particle thickness.

In the above-described two two-layer examples, it is preferable that the thickness of the first porous portion 613 should be not smaller than 0.5 μm. The presence of the first porous portion 613 thereby becomes clear and it is possible to produce an effect of increasing thermal insulation performance. More preferably, the thickness of the first porous portion 613 should be not smaller than 1 μm. In order to ensure the strength of the porous ceramic particle 16, it is preferable that the thickness of the first porous portion 613 should be not larger than one fourth of the particle thickness of the porous ceramic particle 16. Further preferably, the thickness of the first porous portion 613 is not larger than one sixth thereof.

The average porosity of the first porous portion 613 is preferably not lower than 30% and not higher than 95%, more preferably not lower than 40% and not higher than 95%, and especially preferably not lower than 50% and not higher than 95%. The average porosity of the second porous portion 614 is lower than that of the first porous portion 613 and not higher than 75%, more preferably not higher than 70%, and especially preferably not higher than 65%. The average porosity of the second porous portion 614 is preferably not lower than 30%.

A preferable average particle diameter of the skeleton particle in the first porous portion 613 and the second porous portion 614 and preferable thermal conductivity and heat capacity in the first porous portion 613 and the second porous portion 614 are the same as those in the exemplary case of FIG. 3.

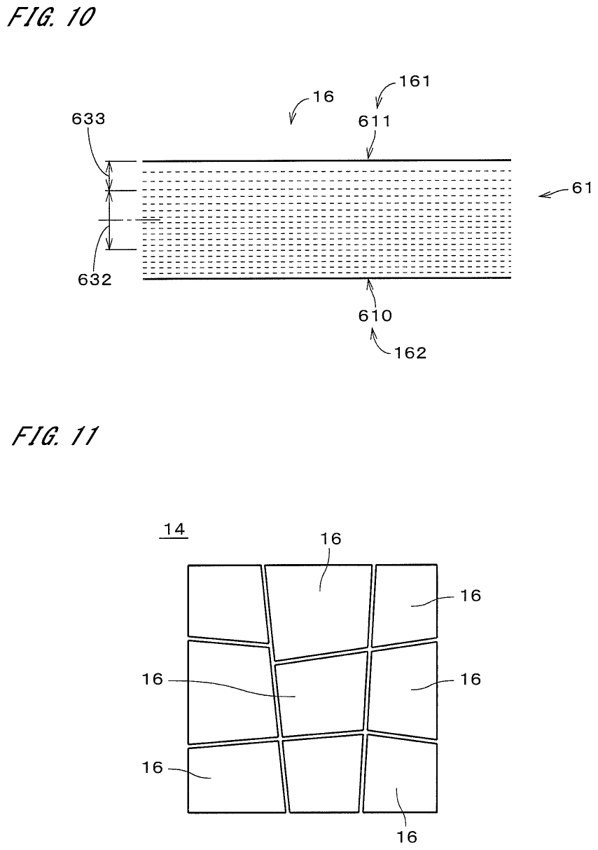

FIGS. 8 and 9 are views for explaining a method of manufacturing the porous ceramic particles 16 in accordance with the two two-layer examples. First, as shown in

FIG. 8, a casting slurry is supplied on the polyester film 32 and the slurry is extended by using the doctor blade or the like so that the thickness after sintering may become a desired thickness and is dried, to thereby provide a first green body 311. Next, as shown in FIG. 9, another casting slurry is supplied on the first green body 311. The slurry is extended by using the doctor blade or the like so that the thickness after sintering may become a desired thickness and is dried, to thereby provide a second green body 312. Through the above-described operation, a green sheet which is a two-layer green body is completed. As another method of forming the second green body 312, screen printing can be used. The first green body 311 corresponds to the second porous portion 614 and the second green body 312 corresponds to the first porous portion 613 shown in FIG. 7.

The method of manufacturing the slurry is the same as that in the exemplary case of FIG. 4. In the case of the first two-layer example, a pore-forming material of the first slurry used for forming the first green body 311 is the same as that of the second slurry used for forming the second green body 312. The amount of pore-forming material of the first slurry per unit volume is less than the amount of pore-forming material of the second slurry per unit volume. In the case of the second two-layer example, the average particle diameter of the pore-forming material of the first slurry used for forming the first green body 311 is smaller than that of the pore-forming material of the second slurry used for forming the second green body 312.

The sintering of the two-layer green body, the formation of the dense layer 62, the adhesion of the original member onto the sheet 12, and the division of the original member are the same as those in the exemplary case of FIG. 3. The arrangement of the porous ceramic aggregate 14 on the object 22, the respective shapes of each porous ceramic particle 16 and the porous ceramic aggregate 14, and the like are also the same as those in the above-described description.

Also in the cases of the first and second two-layer examples, in the porous ceramic particle 16, by increasing the number of open pores in the main surface 611 of the first porous portion 613 which is to become a back-side surface in use or enlarging the open pore, the intrusion of extraneous matters into the open pores can be suppressed. Further, since the porosity of the first porous portion 613 is high and most of the porous portion 61 is the second porous portion 614, a decrease in the strength of the porous ceramic particle 16 can be suppressed. Furthermore, the strength of the front-side surface of the porous ceramic particle 16 is maintained. On the other hand, with the presence of the first porous portion 613, it is possible to reduce the thermal conductivity and the heat capacity as compared with the case where the porous portion 61 is formed only of the second porous portion 614. As a result, it is possible to provide the porous ceramic particle 16 of low thermal conductivity and low heat capacity, in which a decrease in the mechanical strength is suppressed. Various effects produced by the shape and presence of the dense layer 62 are also the same as those in the exemplary case of FIG. 3.

Further, by making the density of the pore-forming material different or making the average particle diameter of the pore-forming material different between the first green body 311 and the second green body 312, it is possible to easily manufacture the above-described porous ceramic particle 16.

Though the porous portion 61 has the two layers having different porosities in FIG. 7, a boundary between the two layers may not be present clearly. FIG. 10 is a view representing the difference in the porosity in the porous portion 61 by the intervals of broken lines. Though the dense layer 62 is omitted in the porous ceramic particle 16 in accordance with the exemplary case of FIG. 10, the dense layer 62 may be provided on the lower surface.

In the porous portion 61, the porosity gradually increases toward the upper main surface 611. Preferably, the porosity increases in the vicinity of the upper main surface 611. Also in the case of the porous portion 61 in FIG. 10, since the porosity in most of the porous portion 61 is lower than that in the vicinity of the upper main surface 611, it is possible to suppress a decrease in the strength of the porous ceramic particle 16. Further, the strength of the front-side surface of the porous ceramic particle 16 is maintained. On the other hand, since the porosity is high in the vicinity of the upper main surface 611, it is possible to reduce the thermal conductivity and the heat capacity. As a result, it is possible to provide the porous ceramic particle 16 of low thermal conductivity and low heat capacity, in which a decrease in the mechanical strength is suppressed.

The structure in which the porosity gradually changes can be easily achieved by gradually changing the density or the particle diameter of the pore-forming material in the green body. There may be a case where the porosity gradually increases toward the upper main surface 611 by providing three or more layers having different porosities in the porous portion 61.

It is preferable that a range in which the porosity is high in the porous portion 61 should be sufficiently smaller than the particle thickness. Specifically, as shown in FIG. 10, the average porosity of the range 633 extending from the upper main surface 161 toward the lower main surface 162 of the porous ceramic particle 16 and having a thickness which is one fourth of the particle thickness is higher than that of the range 632 which is positioned in the center between the pair of main surfaces 161 and 162 and has a thickness which is half of the particle thickness. More preferably, the average porosity of a range extending from the upper main surface 161 toward the lower main surface 162 of the porous ceramic particle 16 and having a thickness which is one eighth of the particle thickness is higher than that of a range which is positioned in the center between the pair of main surfaces 161 and 162 and has a thickness which is three fourth of the particle thickness. By limiting an area having a high porosity to the vicinity of the one main surface 161, it is possible to cause the porous ceramic particle 16 to have low thermal conductivity and low heat capacity and suppress a decrease in the mechanical strength. The upper main surface 161 is a surface to be placed on the object 22.

Though the ranges 632 and 633 are determined with the particle thickness as a reference in the above-described description, since the dense layer 62 is very thin, the ranges 632 and 633 may be determined by using the thickness of the porous portion 61, instead of the particle thickness. In this case, the average porosity of the range 633 extending from the upper main surface 611 toward the lower main surface 610 of the porous portion 61 and having a thickness which is one fourth of the porous thickness is higher than that of the range 632 which is positioned in the center between the pair of main surfaces 611 and 610 and has a thickness which is half of the porous thickness. More preferably, the average porosity of a range extending from the upper main surface 611 toward the lower main surface 610 of the porous portion 61 and having a thickness which is one eighth of the porous thickness is higher than that of a range which is positioned in the center between the pair of main surfaces 611 and 610 and has a thickness which is three fourth of the porous thickness.

In the porous ceramic structure 10, as shown in FIG. 11, preferably, there is at least one porous ceramic particle 16 having a planar shape viewed from an upper surface, which is a polygonal shape surrounded by a plurality of straight lines, among the plurality of porous ceramic particles 16 included in the porous ceramic aggregate 14. In other words, it is preferable that the porous ceramic aggregate 14 should include one porous ceramic particle 16 or two or more porous ceramic particles 16 each having a planar shape which is a polygonal shape. Further, all the porous ceramic particles 16 included in the porous ceramic aggregate 14 may each have a planar shape which is a polygonal shape. When the porous ceramic aggregate 14 includes two or more porous ceramic particles 16 each having a planar shape which is a polygonal shape, the number of vertices of the upper surface of each porous ceramic particle 16 having the planar shape which is a polygonal shape may be equal to or may be different from the number of vertices of the upper surface of each of the other porous ceramic particles 16 having the planar shape which is a polygonal shape.

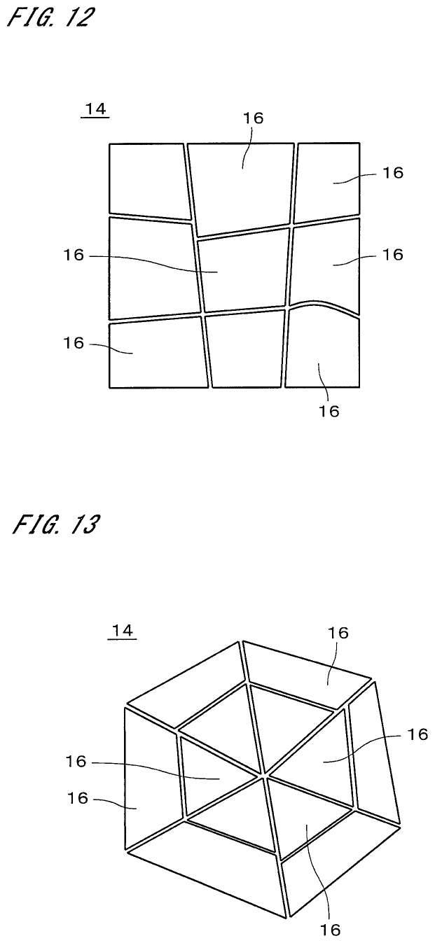

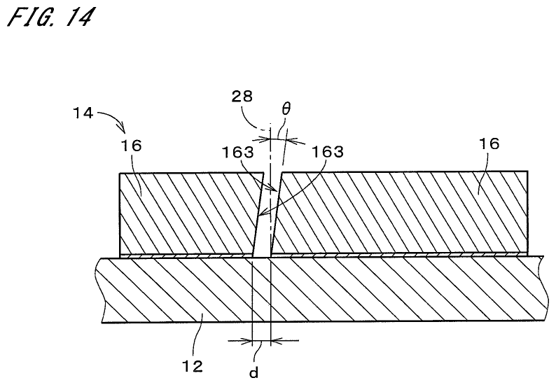

As shown in FIG. 12, for example, the porous ceramic aggregate 14 may include a porous ceramic particle 16 having a planar shape viewed from an upper surface, which includes a curve. Preferably, the ratio of the porous ceramic particle 16 having a planar shape viewed from an upper surface, which includes a curve, to the plurality of porous ceramic particles 16 included in the porous ceramic aggregate 14 is higher than 0% and not higher than 50%. In the porous ceramic aggregate 14, it is possible to suppress positional difference between the porous ceramic particles 16 adjacent to each other with the above-described curve interposed therebetween. When the porous ceramic aggregate 14 is transferred onto the object 22, it is thereby possible to place the plurality of porous ceramic particles 16 on the object 22 with high positional accuracy.

As shown in FIG. 13, the porous ceramic aggregate 14 may have, for example, a portion in which five or more porous ceramic particles 16 are arranged with respective one vertices opposed to one another. Even when there exists a curved surface (for example, a convex surface, a concave surface, or a concave-convex surface) locally on a surface of the object 22, the plurality of porous ceramic particles 16 can be easily arranged along the surface shape of the object 22.

As shown in FIG. 14, in the porous ceramic aggregate 14, the clearance d between adjacent porous ceramic particles 16 is preferably not smaller than 0.01 μm and not larger than 20 μm. It is thereby possible to easily and uniformly transfer the plurality of porous ceramic particles 16 onto the object 22. The above-described clearance d is an interval of the narrowest portion among the clearances between adjacent porous ceramic particles 16. The clearance d is obtained, for example, by measuring the interval between adjacent porous ceramic particles 16 in the porous ceramic aggregate 14 adhered on the sheet 12, with an optical microscope or the like.

In the porous ceramic aggregate 14, when respective side surfaces 163 of the adjacent porous ceramic particles 16 are opposed to each other in parallel, the tilt angle θ of one side surface 163 of the adjacent porous ceramic particles 16 includes a portion having 45 degrees or smaller to a normal 28 of the sheet 12. In other words, the tilt angle θ is preferably not smaller than 0 degrees and not larger than 45 degrees, and further preferably larger than 0 degrees and not larger than 45 degrees. If the tilt angle θ is larger than 45 degrees, there is a possibility that a portion in the vicinity of the side surface 163 of the porous ceramic particle 16 may become chipped. Then, as described above, since the tilt angle θ includes a portion having 45 degrees or smaller, when the porous ceramic particle 16 is transferred onto the object 22 or when the porous ceramic structure 10 is handled, or in the like case, it is possible to prevent or suppress chipping of the porous ceramic particle 16.

The tilt angle θ is obtained, for example, by measuring the interval between adjacent porous ceramic particles 16 in the porous ceramic aggregate 14 adhered on the sheet 12, with the optical microscope or the like. Further, when the clearance between adjacent porous ceramic particles 16 extends in the thickness direction while being bent, the tilt angle θ is an angle formed by a virtual straight line connecting an upper end and a lower end of the side surface 163 of the porous ceramic particle 16 in the longitudinal section and the normal 28.

In the porous ceramic structure 10, preferably, there are different number densities of porous ceramic particles 16 in the porous ceramic aggregate 14. The ratio of a maximum value of the number density to a minimum value thereof (i.e., maximum number density/minimum number density) is preferably larger than 1.2. When the porous ceramic aggregate 14 of the porous ceramic structure 10 is transferred onto the object 22, it is thereby possible to cause the plurality of porous ceramic particles 16 to be easily arranged while following the surface of the object 22 with high accuracy.

In the porous ceramic structure 10, preferably, the plurality of porous ceramic particles 16 have respective planar shapes of different sizes. The ratio of a maximum value of the size of the planar shape to a minimum value thereof (i.e., maximum area/minimum area) is preferably larger than 1.2. Similarly in this case, when the porous ceramic aggregate 14 of the porous ceramic structure 10 is transferred onto the object 22, it is thereby possible to cause the plurality of porous ceramic particles 16 to be easily arranged while following the surface of the object 22 with high accuracy.

Specifically, for example, in a portion of the porous ceramic aggregate 14 which is to be transferred onto an area where the surface of the object 22 is flat, the number density is reduced and the planar shape of the porous ceramic particle 16 is made larger, and in another portion of the porous ceramic aggregate 14 which is to be transferred onto an area where the surface of the object 22 is curved, the number density is increased and the planar shape of the porous ceramic particle 16 is made smaller, and it is thereby possible to cause the plurality of porous ceramic particles 16 to be arranged while following the surface of the object 22.

The above-described number density can be obtained, for example, by observing any field of view of a plurality of portions in the porous ceramic aggregate 14 adhered on the sheet 12 with the optical microscope or the like and dividing the number of porous ceramic particles 16 included in each field of view by the area of field of view. Further, the size of the above-described planar shape is obtained for each of the above plurality of fields of view. Specifically, for example, a plurality of straight lines are arbitrarily drawn in each of the above-described fields of view and an average value of lengths of line segments in the porous ceramic particle 16 crossing the straight lines is obtained as the size of the planar shape of the porous ceramic particle 16 in each field of view.

In the porous ceramic structure 10, the tensile elongation (JIS K7127) of the sheet 12 is preferably not lower than 0.5%. Even when the surface of the object 22 is curved, it is thereby possible to cause the plurality of porous ceramic particles 16 on the sheet 12 to be easily arranged while following the surface of the object 22 with high accuracy. Further, the thickness of the sheet 12 is preferably larger than 0 mm and not larger than 5 mm. Even when the surface of the object 22 is curved, it is thereby possible to cause the plurality of porous ceramic particles 16 on the sheet 12 to be easily arranged while following the surface of the object 22 with high accuracy.

The above-described porous ceramic structure 10 and porous ceramic particle 16 allow various variations.

The sheet 12 which is the supporting member is not limited to the resin sheet or the resin film having an adhesive force, but various materials may be adopted. Preferably, the sheet 12 is any one of a resin, cloth (fabric, nonwoven fabric, or the like), rubber, wood, paper, carbon, a metal, ceramic, and glass or a composite material of two or more materials selected from these materials. As a matter of course, the material of the sheet 12 is not limited to these materials.

As the structure of the sheet 12, various structures may be adopted. For example, the sheet 12 may be formed by applying the adhesive agent or the like onto a base material. The sheet 21 may be a sheet in which another member is adhered or joined onto the base material. The material of the sheet-like member to be adhered or joined onto the base material is preferably any one of a resin, cloth (fabric, nonwoven fabric, or the like), rubber, wood, paper, carbon, a metal, ceramic, and glass or a composite material of two or more materials selected from these materials. The layer to be provided on the base material is not limited to one layer but may be a plurality of layers.

In a case where the surface of the object 22 is curved, the base material of the sheet 12 is preferably cloth, a rubber sheet, foam, or the like. Thus, by using the base material which is relatively soft and has elasticity, it is possible to cause the plurality of porous ceramic particles 16 on the sheet 12 to be easily arranged while following the surface of the object 22 with high accuracy.

In a case where the surface of the object 22 is flat, the base material of the sheet 12 is preferably a film, a metal foil, paper, or the like. Also in the case where the surface of the object 22 is flat, various materials may be adopted for the base material of the sheet 12, and the base material of the sheet 12 is preferably any one of a resin, wood, a metal, and ceramic or a composite material of two or more materials selected from these materials. Thus, by using a relatively hard base material, it is possible to prevent or suppress positional difference of the porous ceramic particles 16 due to occurrence of wrinkle in the sheet 12 when the plurality of porous ceramic particles 16 are transferred onto the surface of the object 22. Both in the cases where the surface of the object 22 is curved and where the surface of the object 22 is flat, the material of the base material of the sheet 12 is not limited to the above-described examples.

Further, in the above-described preferred embodiment, the supporting member supporting the porous ceramic aggregate 14 is a sheet-like one, but the supporting member is not limited to the sheet-like one. The supporting member may be, for example, a three-dimensional mold member. In the case where the surface of the object 22 is curved, a curved supporting surface in accord with the curved surface is provided in the mold member, and the porous ceramic aggregate 14 is supported on the supporting surface. The supporting surface may be a plane surface, a curved surface, a spherical surface, or the like, or may have a further complicated shape. As materials for the mold member, various materials may be adopted. The material of the mold member is preferably any one of a resin, rubber, wood, a metal, ceramic, glass, cloth (fabric, nonwoven fabric, or the like), paper, and carbon or a composite material of two or more materials selected from these materials. The material of the mold member is not limited to these materials.

The method of manufacturing the porous ceramic particle 16 and the method of manufacturing the porous ceramic structure 10 are not limited to the above-described methods but may be changed in various manners.

Though the porous ceramic aggregate 14 and the porous ceramic particle 16 are used, for example, for forming the thermal insulation film on the object in the above-described preferred embodiment, the structure of the porous ceramic particle 16 may be used for a porous ceramic aggregate or a porous ceramic particle to be used for any purpose other than thermal insulation. The porous ceramic aggregate 14 and the porous ceramic particle 16 described above are suitable, for example, for a case where it is required to ensure the strength while maintaining the porosity to some degree in a film formed of the porous ceramic particles.

The porous ceramic aggregate 14 or the porous ceramic particle 16 of the above-described preferred embodiment may be used while being sandwiched between two objects, for the purpose of thermal insulation between the objects. Further, the porous ceramic aggregate 14 or the porous ceramic particle 16 may be used while being sandwiched between the objects for other purposes, instead of being used for the purpose of thermal insulation between the objects.

The configurations in the above-discussed preferred embodiment and variations may be combined as appropriate only if those do not conflict with one another.

While the invention has been shown and described in detail, the foregoing description is in all aspects illustrative and not restrictive. It is therefore understood that numerous modifications and variations can be devised without departing from the scope of the invention.

### REFERENCE SIGNS LIST

10 Porous ceramic structure

12 Sheet (supporting member)

14 Porous ceramic aggregate

16 Porous ceramic particle

22 Object

62 Dense layer

161, 162 Main surface (of porous ceramic particle)

615 Recessed portion

613 First porous portion

614 Second porous portion

1. A porous ceramic particle which has a plate-like shape having a pair of main surfaces in parallel with each other, wherein
an average porosity in a range of one fourth of a particle thickness which is a distance between said pair of main surfaces, said range of one fourth of a particle thickness existing from one main surface toward the other main surface among said pair of main surfaces, is higher than that in a range of half of said particle thickness, which is positioned in the center between said pair of main surfaces.

2. The porous ceramic particle according to claim 1, wherein
a plurality of recessed portions each of which is larger than a pore which is open in said one main surface are present in said one main surface, and
a range in which said plurality of recessed portions are present in a thickness direction is not smaller than 0.5 μm and not larger than one fourth of said particle thickness.

3. The porous ceramic particle according to claim 1, comprising:
a first porous portion including said one main surface, pores being present substantially uniformly in said first porous portion; and
a second porous portion being in contact with said first porous portion and including said range which is positioned in the center between said pair of main surfaces and has a thickness which is half of said particle thickness, pores being present substantially uniformly in said second porous portion,
wherein the average porosity of said first porous portion is higher than that of said second porous portion.

4. The porous ceramic particle according to claim 1, comprising:
a first porous portion including said one main surface, pores being present substantially uniformly in said first porous portion; and
a second porous portion being in contact with said first porous portion and including said range which is positioned in the center between said pair of main surfaces and has a thickness which is half of said particle thickness, pores being present substantially uniformly in said second porous portion,
wherein the average pore diameter of said first porous portion is larger than that of said second porous portion.

5. The porous ceramic particle according to claim 3, wherein
the thickness of said first porous portion is not smaller than 0.5 μm and not larger than one fourth of said particle thickness.

6. The porous ceramic particle according to claim 3, wherein
the average porosity of said first porous portion is not lower than 30% and not higher than 95%, and
the average porosity of said second porous portion is not lower than 30% and lower than that of said first porous portion.

7. The porous ceramic particle according to claim 1, wherein
not smaller than 50% of said other main surface is a surface of a dense layer.

8. A porous ceramic structure comprising:
a supporting member; and
a porous ceramic aggregate adhered on said supporting member,
wherein said porous ceramic aggregate includes a plurality of porous ceramic particles each of which has the same structure as that of a porous ceramic particle according to claim 1, and
said plurality of porous ceramic particles are arranged, with respective side surfaces thereof opposed to each other, and said other main surfaces of said plurality of porous ceramic particles are adhered on said supporting member.

9. The porous ceramic structure according to claim 8, wherein
said porous ceramic aggregate is a member to be placed on an object, and
a planar shape of said porous ceramic aggregate viewed from an upper surface is the same as that of an area of said object viewed from an upper surface, said porous ceramic aggregate being to be placed on said area.

10. The porous ceramic structure according to claim 8, wherein
a clearance between adjacent porous ceramic particles in said porous ceramic aggregate is not smaller than 0.1 μm and not larger than 20 μm.

11. The porous ceramic structure according to claim 8, wherein
there are different number densities of porous ceramic particles in said porous ceramic aggregate, and
a ratio of a maximum value of said number density to a minimum value thereof is larger than 1.2.

12. The porous ceramic structure according to claims 8, wherein
a material of said supporting member is any one of a resin, cloth, rubber, wood, paper, carbon, a metal, ceramic, and glass or a composite material of two or more materials selected from these materials.
